(19) United States
(12) Patent Application Publication
(10) Pub. No.: US 2008/0161014 A1
(43) Pub. Date: Jul. 3, 2008

(54) Device for Locating a Mobile Terminal by Means of Corrected Time-Stamping Signals from Base Stations of an Asynchronous Mobile Network

(75) Inventor: Michel Monnerat, L'Union (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL, Paris (FR)

(21) Appl. No.: 11/720,434

(22) PCT Filed: Oct. 27, 2005
(86) PCT No.: PCT/FR05/50906

§ 371 Date: Nov. 28, 2007

(30) Foreign Application Priority Data
Nov. 30, 2004 (FR) 0452813

(51) Int. Cl. H04Q 7/00

(52) U.S. Cl. 455/456.1

(57) ABSTRACT

The inventive device is used for locating one or several mobile terminals (UE1, UE2, UE3) situated in cells (C1, C2, C3) of an asynchronous mobile communications network (R) controlled by the base stations (BTS1, BTS2, BTS3), wherein said network comprises an assistance server (SA) storing time offsets of clocks of the base stations with respect to a reference clock (for example, the clock of a radio navigation satellite system CS). Said locating device (D) comprises processing means (MT) for collecting, in the case of location request from a mobile terminal (UE1), analysable signals which are received from at least two base stations (BTS1, BTS2, BTS3) and provided with a representative time stamping of a time interval selected with respect to the clock of the base stations thereof and representative data of time offsets of said base stations (BTS1, BTS2, BTS3), and to determine the position of the mobile terminal (UE1) by triangulation on the basis of the analysable signals and collected data.

The invention concerns asynchronous mobile communication networks, and more precisely locating within such networks mobile terminals having no radio navigation satellite receiver (of RNSS or GNSS type).

Here “mobile terminal” means any mobile radio communication equipment capable of exchanging radio signals with the (radio) base stations controlling calls within cells of an asynchronous mobile communication network, such as a GSM, GPRS/EDGE or UMTS network, for example. It may thus be a question of a mobile telephone (or user equipment), a laptop computer or a personal digital assistant (PDA) equipped with radio communication means for setting up telephone radio connections.

In certain situations, in particular emergencies, it may prove particularly useful to locate the position of a mobile terminal with some accuracy. In some countries, such as the United States of America, for example, such location may even be a function that has to be triggered automatically in case of using a mobile telephone to call an emergency number (911).

The accurate location of a mobile terminal is a relatively easy operation if the latter is equipped with a radio navigation satellite receiver (of RNSS (Radio Navigation Satellite System) or GNSS (Global Navigation Satellite System) type).

However, the accurate location of a mobile terminal is not so easy in the absence of any such satellite radio navigation receiver. At least two location techniques have been proposed for this purpose.

A first technique is known by the English-language acronym EOTD (Enhanced Observed Time Difference). It consists in having a mobile terminal transmit a primary signal to the base stations around it, and then in each base station that receives the primary signal adding a time stamp representing the time of reception of said primary signal, and having each base station transmit to a location server a signal to be analyzed consisting of the primary signal and the time stamp. On receiving signals to be analyzed coming from at least two base stations and derived from the same primary signal, the location server is then in a position to determine by triangulation the position of the mobile terminal that sent the primary signal.

A second technique is known by the English-language acronym TOA (Time Of Arrival). It consists in having the base stations around a mobile terminal transmit simultaneously signals to be analyzed including a time stamp representing their sending time and, on reception by the mobile terminal of signals to be analyzed coming from at least two base stations and including a time stamp representing the same sending time, determining the position of the mobile terminal that sent that primary signal by triangulation on the basis of said sending time and the times of receiving the signals to be analyzed.

These two techniques are based on a time stamp representing the receiving or sending time of a signal relative to the internal clock of the base station concerned. Now, as the person skilled in the art is aware, the internal clocks of the base stations of an asynchronous mobile network are not perfectly synchronous. In fact they have a greater of lesser offset relative to each other.

The time stamping of the signals being effected by base stations that are not well synchronized, the accuracy of the positions of the mobile terminals can prove insufficient in relation to that imposed by certain specifications (or local or international legislation).

To solve this problem, the operator of an asynchronous mobile network can for example equip each base station with a radio navigation receiver for synchronizing it to the reference clock of an RNSS or GNSS system. It can also use location mobile units (LMU) to synchronize the base stations with each other. However, these synchronization solutions prove very costly.

No known solution providing complete satisfaction, an object of the invention is therefore to improve on the situation.

To this end it proposes a device dedicated to locating one or more mobile terminals situated in the cells of an asynchronous mobile communication network that are controlled by base stations, the network including an assistance server storing time offsets of clocks of the base stations relative to a reference clock (for example that of a radio navigation satellite system).

This location device is characterized in that it comprises processing means adapted, in case of a location request by a mobile terminal, to collect, on the one hand, signals to be analyzed coming from at least two base stations and including a time stamp representing a chosen time relative to the clock of their base station and, on the other hand, data representing the time offsets of the base stations and to determine the position of the mobile terminal by triangulation on the basis of said signals to be analyzed and the collected data.

The device according to the invention may have other features and in particular, separately or in combination:
the time stamp may represent the time of reception by a base station of a primary signal transmitted by the requesting mobile terminal. Alternatively, the time stamp may represent the sending time, relative to the internal reference time of the base station, of a primary signal transmitted by the requesting mobile terminal (for example as a function of a marking relative to the frames previously received from the base station concerned, the regular framing whereof marks its own internal reference time). In either case, each signal to be analyzed, which comes from a base station, consists of the primary signal and the time stamp applied by the base station or by the mobile terminal;
   the processing means may then be made responsible for modifying the time stamp of each signal to be analyzed received from a base station as a function of the time offset of the clock of that base station and for then determining the position of the mobile terminal by triangulation, in the manner of the EOTD technique, on the basis of the modified time stamps of the signals to be analyzed derived from the same primary signal;
alternatively, the time stamp may represent the time of sending by a base station of the signal to be analyzed or the time, relative to an internal reference time of the base station, of the mobile terminal receiving the signal to be analyzed transmitted by that base station;
   the processing means may then be made responsible for modifying the time stamp of each signal to be analyzed received from a base station as a function of the time offset of the clock of that base station and for then determining the position of the mobile terminal by triangulation, in the manner of the TOA technique, on the basis of the modified time stamps of the signals to be analyzed coming from the base stations and the times of receiving the signals to be analyzed.

The invention also proposes a mobile terminal for an asynchronous mobile communication network comprising cells controlled by base stations and an assistance server storing the time offsets of the clocks of the base stations relative to a reference clock (for example that of a radio navigation satellite system) equipped with the above type of location device.

The invention further proposes a location server for a mobile communication network comprising cells controlled by base stations and an assistance server storing time the offsets of clocks of the base stations relative to a reference clock (for example that of a radio navigation satellite system) equipped with the above type of location device. Such a location server can for example constitute a serving mobile location center (SMLC).

The invention is particularly well adapted, although not exclusively so, to cellular radio networks of GSM, GPRS/EDGE or UMTS type.

Other features and advantages of the invention will become apparent on reading the following detailed description and examining the appended drawings, in which:

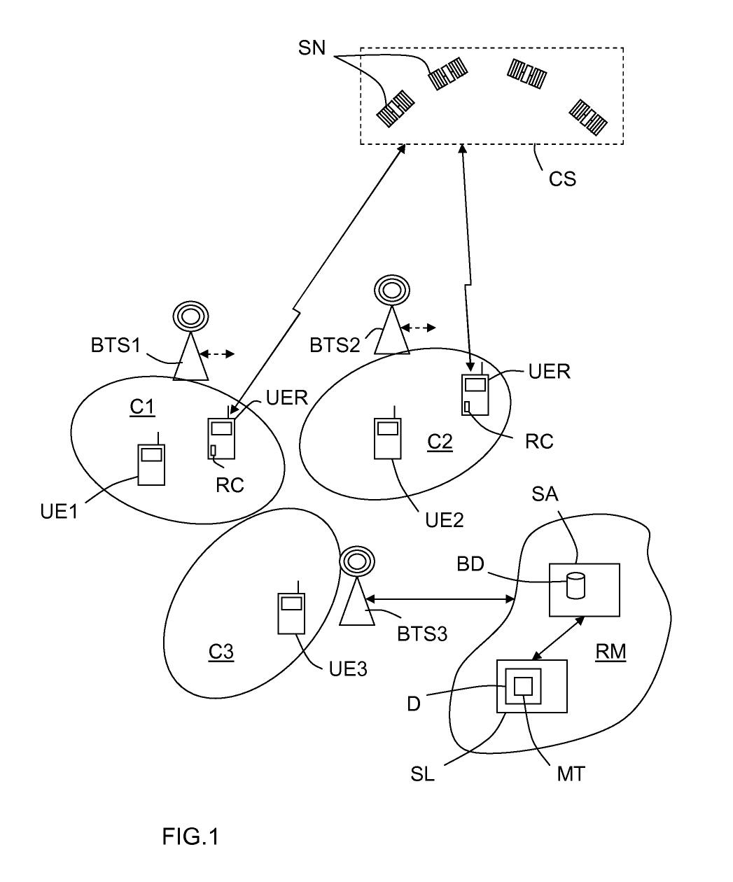

FIG. 1 shows very diagrammatically a first example of an asynchronous mobile network coupled to a GNSS system and including a location server equipped with a first embodiment of a location device according to the invention, and

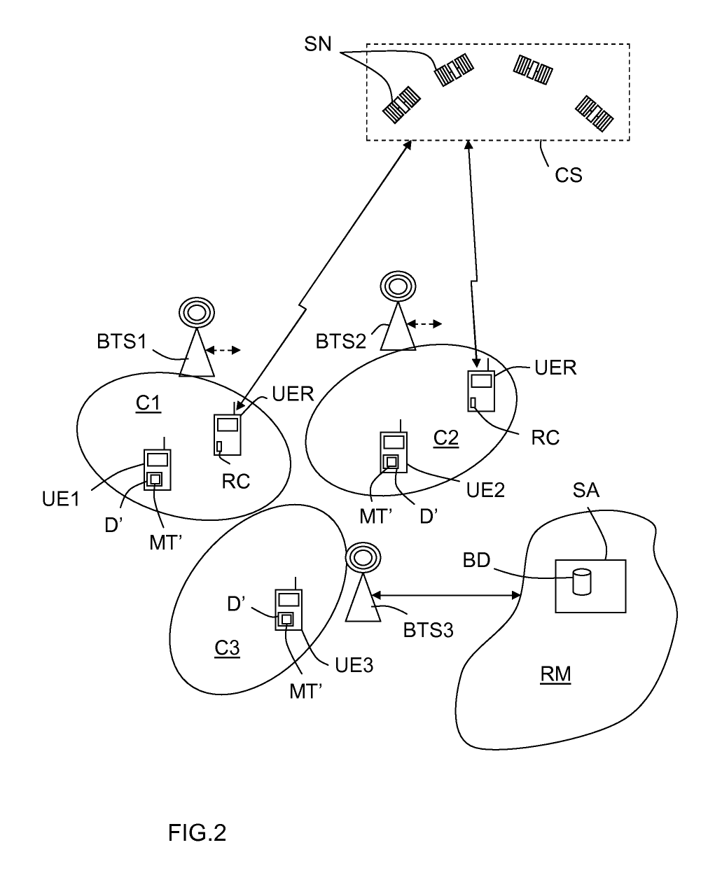

FIG. 2 shows very diagrammatically a second example of an asynchronous mobile network coupled to a GNSS system and including mobile terminals equipped with a second embodiment of the location device according to the invention.

The appended drawings constitute part of the description of the invention as well as contributing to the definition of the invention, if necessary.

An object of the invention is to enable location of mobile terminals of an asynchronous mobile communication network with a high level of accuracy.

Hereinafter, it is considered by way of nonlimiting example that the asynchronous mobile network is a GSM network. The invention is not limited to that type of network, however. In fact it concerns all asynchronous mobile networks and in particular GPRS/EDGE and UMTS networks.

Moreover, it is considered hereinafter, by way of nonlimiting example, that the mobile terminals are mobile telephones. The invention is not limited to that type of mobile terminal, however. In fact it concerns all radio communication equipments capable of exchanging radio signals with the base stations that control calls within cells of the asynchronous mobile networks, and in particular laptop computers and personal digital assistants (PDA) equipped with radio communication means enabling radio telephone connections to be set up.

FIG. 1 is referred to first of all to describe a first asynchronous mobile network RM (of GSM type) coupled to a radio navigation system of GNSS (or RNSS) type, for example a GPS (Global Positioning System), GLONASS or GALILEO system.

Very broadly speaking, but nevertheless in sufficient detail for the invention to be understood, a GSM network RM can be summarized as a core network coupled to a radio access network call the BSS, both of which are connected to a network management system (NMS).

The radio access network (BSS) includes a set of base stations called base transceiver stations (BTS) and radio network controllers or nodes called base station controllers (BSC), connected to each other, and a radio access network manager.

Each base station BTSi (here i is from 1 to 3, but may take any value greater than or equal to 3) is associated with at least one cell Ci covering a radio area in which mobile telephones UEi and UER can set up (or continue) radio connections.

In the example shown, three cells (C1-C3, i=1 to 3) have been represented, each being controlled by one of the three base stations BTSi.

Each base station BTSi includes an internal clock.

The core network comprises a set of network equipments connected to the radio network controllers (BSC) and to a core network manager.

In the example shown, the core network (CN) and the radio access network (BSS), apart from its base stations BTSi, are lumped together and represented by the irregular shape referenced RM.

In this first embodiment, the GSM network RM comprises at least one location device D responsible for determining the positions of mobile telephones UEj (here j is from 1 to 3 but may take any non-zero value).

As shown here, this location device D can form part of a location server SL which can for example constitute a serving mobile location center (SMLC). Such a location server SL can be installed in a base station controller (BSC) providing the location function. The location device D could be an equipment connected to the GSM network, for example at the level of its radio access network (BSS), however. It could equally form part of a gateway (or portal) of the GSM network, called the gateway mobile location center (GMLC), or be connected to said GMLC.

According to the invention, the location device D includes a processing module MT responsible, when a mobile telephone UEj effects a location request, for collecting, on the one hand, signals to be analyzed coming from at least two base stations BTSi and including a time stamp representing a chosen time relative to the clock of their base station BTSi and, on the other hand, data representing the time offsets of those base stations BTSi relative to a GSM network reference time, and for determining the position of the requesting mobile terminal by triangulation on the basis of the signals to be analyzed and the data that it has collected.

In this first embodiment, when a mobile telephone UEj (for example UE1 that is situated at a given time in the cell C1) requests the device D to determine its position, it sends a primary signal to the base stations BTSi around it.

When a base station BTSi receives the primary signal, it adds to it a time stamp that represents its reception time relative to its internal clock.

Alternatively, the time stamping can be effected by the mobile telephone UE at the time of sending the primary signal. This time stamping is then effected relative to the internal reference time defined by the internal clock of the base station BTSi. In fact, the frames transmitted to the mobile telephone UE by a base station BTSi include a regular framing that marks its internal reference time. The mobile telephone UE can therefore time stamp an event according to the internal clock of a given base station BTSi by virtue of the framing of the signals that it has received from that base station BTSi.

Any technique for adding time stamps may be envisaged. The base station BTSi then transmits a signal to be analyzed consisting of the primary signal and the time stamp to the location device D.

When the processing module MT has at least two, and preferably three or even four, signals to be analyzed coming from two (or three or even four) base stations BTSi and derived from the same primary signal, it is then in a position to proceed to the determination of the position of the requesting mobile telephone UE1. However, it must collect data representing the time offsets of the base stations BTSi that transmitted the signals to be analyzed relative to the reference time of the GSM network.

That data can for example be collected from an assistance server SA including a database BD in which are stored the latest known time offsets of the base stations BTSi of the GSM network RM.

The Applicant has proposed in the patent document FR 0314699 a system and a method for obtaining time offsets of base stations of an asynchronous mobile network. The descriptive content of that patent document is incorporated herein by reference with the aim of providing a detailed example of the means for obtaining time offsets of base stations BTSi. Such a system will therefore not be described in detail here.

Suffice to say that this system is based on the use of:
a radio navigation system of GNSS type, for example GPS type, including a constellation CS of positioning satellites SN having a common clock of very high accuracy defining a reference time, generally called the “system time”, each satellite SN being responsible for transmitting satellite data used for positioning;
mobile terminals UER, for example mobile telephones, equipped with a radio navigation receiver RC, for example of GPS type, responsible for determining at least satellite/terminal pseudo-distances from satellite data received from at least three satellites of the constellation CS, and
an assistance server SA, sometimes called an assisted-GPS (A-GPS) server, responsible for improving the acquisition of satellite data by the mobile terminals UER.

In this system, when a mobile terminal UER receives satellite data, it computes terminal/satellite pseudo-distances, encapsulates those pseudo-distances with the time of day at which they were computed, and transmits this combination in the form of a radio signal to the assistance server SA via the base station BTSi that controls the cell in which it is situated. The base station BTSi can insert into the radio signal received from the mobile terminal UER its reception time of day as it passes through. Alternatively, and as indicated hereinabove, the mobile telephone UE can equally insert a time stamp relative to the internal reference time of the base station BTSi. The assistance server SA then determines a first time offset (or clock skew) between the clock of the mobile telephone UER and the common clock of the satellites of the constellation CS. It then estimates a second time offset (or clock skew) between the clock of the mobile telephone UER and the internal clock of the base station BTSi by establishing the difference between the sending time of day and the receiving time of day. Finally, it determines the time offset (or clock skew) between the common clock of the satellites SN of the constellation CS and the internal clock of the base station BTSi by establishing the difference between the first and second time offsets. The time offset of the base station BTSi relative to the time reference (or system time) of the constellation CS is then stored in the database BD that is used to update the internal clocks of the base stations BTSi of the GSM network.

By interrogating the assistance server SA, the location device D according to the invention can collect the data representing the time offsets of the base stations BTSi that have sent it signals to be analyzed. On reception of this data, its processing module MT modifies the time stamp of each signal to be analyzed as a function of the time offset of the internal clock of the base station that sent it.

More precisely, the processing module MT adds or subtracts the time offset of the internal clock of the base station BTSi to or from the time at which it received the primary signal (time stamping), according to whether its internal clock is slow or fast relative to the reference time (or system time).

The processing module MT then determines the position of the mobile telephone UE1 by triangulation, in the manner of the EOTD technique, on the basis of the modified time stamps of the various signals to be analyzed derived from the primary signal sent by said mobile telephone UE1.

The position determined is then transmitted to at least one requesting mobile telephone UE1 by the device D via the base station BTS1 that controls the cell C1 in which it is situated.

Reference is now made to FIG. 2 to describe a second asynchronous mobile network (of GSM type) RM coupled to a radio navigation system of GNSS (or RNSS) type, for example a GPS system. The second network is substantially identical to that described hereinabove with reference to FIG. 1. What makes it different from the latter is the fact that the positions of the mobile telephones UEj are no longer determined by a location device D coupled to the radio access network (BSS), but by location devices D′ installed in the mobile telephones UEj.

In this second embodiment, when a mobile telephone UEj (for example UE1 that is situated at a given time in the cell C1) requires its device D′ to determine its position, it alerts the GSM network RM. The latter instructs the base stations BTSi “around” (or situated in the vicinity of) the requesting mobile telephone UE1 to transmit to it simultaneously a signal to be analyzed including a time stamp representing its sending time relative to their internal clock.

Alternatively, the time stamp can be added by the mobile telephone UE1 when it receives the signal to be analyzed from a base station BTSi. In this case, the time stamping effected by the mobile terminal UE1 represents the time at which it receives the signal to be analyzed transmitted by the base station BTSi relative to the internal reference time of that base station BTSi. As indicated hereinabove, the frames transmitted to the mobile telephone UE by a base station BTSi feature regular framing that marks its internal reference time. The mobile telephone UE can therefore time stamp an event (here the reception of the signal to be analyzed) according to the internal clock of a given base station BTSi by virtue of the framing of the signals that it has received from that base station BTSi.

Any technique for adding a time stamp may be envisaged.

When the requesting mobile terminal UE1 receives the signal to be analyzed transmitted by the adjacent base stations BTSi, it communicates them to its location device D′. The latter then communicates them to its processing module MT′ which stamps their respective reception times and, if it has at least two, and preferably three, or even four, signals to be analyzed coming from two (or three, or even four) base stations BTSi, is then in a position to determine the position of the requesting mobile telephone UE1. However, it must collect data representing the time offsets of the base stations BTSi that transmitted the signals to be analyzed relative to the reference time of the GSM network.

As in the first embodiment, the data representing the time offsets of the base stations BTSi can be collected from the assistance server SA.

In this case, the location device D′ according to the invention requests the assistance server SA, via the base station BTS1 that controls the cell C1 in which its mobile telephone UE1 is situated, to extract the data representing the time offsets of the base stations BTSi that transmitted the signals to be analyzed to it in order to transmit them to it, again via the base station BTS1.

On receiving this data, the mobile telephone UE1 communicates it to the location device D′, which transmits it to its processing module MT′. The latter modifies the time stamp of each signal to be analyzed as a function of the time offset of the internal clock of the base station BTSi that transmitted it.

More precisely, the processing module MT adds or subtracts the time offset of the internal clock of the base station BTSi to or from the time at which it sent the signal to be analyzed (time stamping), according to whether its internal clock is slow or fast relative to the reference time (or system time). It then determines the difference between each modified sending time (or modified time stamp) and the reception time of the corresponding signal to be analyzed.

The processing module MT′ then determines the position of the mobile telephone UE1 by triangulation, in the manner of the TOA technique, on the basis of the differences that it has just determined.

The determined position is then communicated to an application of the mobile telephone UE1, which may transmit it to the GSM network RM via the base station BTS1 that controls the cell C1 in which it is situated.

The location device D or D′ according to the invention, and in particular its processing module MT or MT′, can be produced in the form of electronic circuits, software (or electronic data processing) modules, or a combination of circuits and software.

The invention is not limited to the location device, mobile terminal and location server embodiments described hereinabove by way of example only, but encompasses all variants that the person skilled in the art might envisage within the scope of the following claims.

1. Device (D; D′) for location of mobile terminals (UEj) situated in one of the cells (Ci) of an asynchronous mobile communication network (RM) that are controlled by base stations (BTSi), said network (RM) including an assistance server (SA) storing time offsets of clocks of said base stations relative to a reference clock, characterized in that it comprises processing means (MT; MT′) adapted, in case of a location request by a mobile terminal (UE1), to collect, on the one hand, signals to be analyzed coming from at least two base stations (BTSi) and including a time stamp representing a chosen time relative to the clock of their base station (BTSi) and, on the other hand, data representing the time offsets of said base stations (BTSi) and to determine a position of said mobile terminal (UE1) by triangulation on the basis of said signals to be analyzed and said collected data.

2. Device according to claim 1, characterized in that said time stamp represents the time of reception by a base station (BTSi) of a primary signal transmitted by said requesting mobile terminal (UE1) and each signal to be analyzed coming from a base station (BTSi) consists of said primary signal and said time stamp effected by said base station (BTSi).

3. Device according to claim 1, characterized in that said time stamp represents the time relative to an internal reference time of said base station (BTSi) of sending a primary signal transmitted by said requesting mobile terminal (UE1) and each signal to be analyzed coming from a base station (BTSi) consists of said primary signal and said time stamp effected by said mobile terminal (UE1).

4. Device according to claim 2, characterized in that said processing means (MT) are adapted to modify the time stamp of each signal to be analyzed received from a base station (BTSi) as a function of the time offset of the clock of that base station (BTSi) and then to determine the position of said mobile terminal (UE1) by triangulation on the basis of said modified time stamps of the signals to be analyzed derived from the same primary signal.

5. Device according to claim 1, characterized in that said time stamp represents the time of sending of said signal to be analyzed by a base station (BTSi).

6. Device according to claim 1, characterized in that said time stamp represents the time relative to an internal reference time of said base station (BTSi) of reception by said mobile terminal (UE1) of said signal to be analyzed transmitted by that base station (BTSi).

7. Device according to claim 5, characterized in that said processing means (MT′) are adapted to modify the time stamp of each signal to be analyzed received from a base station (BTSi) as a function of the time offset of the clock of that base station (BTSi) and then to determine the position of said mobile terminal (UE1) by triangulation on the basis of said modified time stamps of said signals to be analyzed coming from said base stations (BTSi) and the times of reception of said signals to be analyzed.

8. Mobile terminal (UEi) for an asynchronous mobile communication network (RM) comprising cells (Ci) controlled by base stations (BTSi) and an assistance server (SA) storing time offsets of clocks of said base stations (BTSi) relative to a reference clock, characterized in that it comprises a location device (D′) according to claim 1.

9. Location server (SL) for a mobile communication network (RM) comprising cells (Ci) controlled by base stations (BTSi) and an assistance server (SA) storing time offsets of clocks of said base stations (BTSi) relative to a reference clock, characterized in that it comprises a location device (D) according to claim 1.

10. Server according to claim 9, characterized in that it constitutes a serving mobile location center (SMLC).

11. Use of the location device (D; D′), the mobile terminal (UEi) and the location server (SL) according to claim 1 in cellular radio networks chosen in a group comprising GSM, GPRS/EDGE and UMTS networks.
